(19) United States
(12) Patent Application Publication
(10) Pub. No.: US 2005/0041588 A1
(43) Pub. Date: Feb. 24, 2005

(54) Apparatus and method for assigning channel in a mobile communication system using HARQ

(75) Inventors: Youn-Sun Kim, Seongnam-si (KR); Hwan-Joon Kwon, Hwaseong-gun (KR); Dong-Hee Kim, Seoul (KR); Jin-Kyu Han, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/921,614

(22) Filed: Aug. 19, 2004

(30) Foreign Application Priority Data
Aug. 19, 2003 (KR) 57392-2003

(51) Int. Cl. H04L 12/26

(52) U.S. Cl. 370/236; 370/232

(57) ABSTRACT

A method of efficiently assigning a plurality of reverse HARQ channels to an MS in a BS in a mobile communication system supporting HARQ is provided. To transmit reverse data to the BS, the MS transmits a reverse data rate request message to the BS, receives from the BS one grant message containing a reverse data rate, and transmits to the BS different packet data at predetermined intervals at the reverse data rate on a packet data channel.

### PRIORITY

This application claims priority under 35 U.S.C. § 119 to an application entitled “Apparatus and Method for Assigning Channel in a Mobile Communication System Using HARQ” filed in the Korean Intellectual Property Office on Aug. 19, 2003 and assigned Serial No. 2003-57392, the contents of which are incorporated herein by reference.

### BACKGROUND OF THE INVENTION

1. Field of the Invention

The present invention relates generally to a channel assigning apparatus and method in a mobile communication system, and in particular, to an apparatus and method for assigning channels in a mobile communication system using HARQ (Hybrid Automatic Repeat reQuest).

2. Description of the Related Art

Typically, mobile communication systems support voice service only or support both voice service and data service. CDMA (Code Division Multiple Access) is a major example. An existing CDMA system supporting voice service only is based on the IS-95 standards. Growing user demands and the resultant development of mobile communication technology have driven mobile communication systems toward high-speed data service. CDMA2000 was proposed to support both voice service and high-speed data service.

During data transmission/reception via a radio link, data may be damaged or lost in a mobile communication system. As a main real-time service, voice service experiences data damage or loss, and there is no need for retransmitting data. However, in the case of packet data service, a message is valid only when damaged or lost data is retransmitted. Hence, communication systems for data transmission perform data retransmission in various ways.

Retransmission schemes used in wireless communication systems include RLP (Radio Link Protocol) retransmission and HARQ. The RLP retransmission will first be described below.

In the RLP retransmission scheme, upon generation of reception errors, the RLP layer of a base station (BS) notifies a mobile station (MS) of the errors via a signaling channel on the reverse link. The MS then retransmits the same packet data. The same thing applies to the forward link from the BS to the MS. A distinctive shortcoming of the RLP retransmission scheme is that a long time is taken between initial transmission of error-containing traffic data and its retransmission because the BS processes the packet data not in the physical layer but in the RLP layer or in its upper layer. Another shortcoming is that received data having errors cannot be reused. Therefore, it is preferable to minimize RLP retransmission in the typical communication system.

In this context, HARQ is adopted as a more efficient retransmission method in the wireless communication system. The HARQ scheme can overcome the shortcomings of the RLP retransmission scheme. In the HARQ scheme, the physical layer detects errors and requests retransmission. When errors occur during transmission from a transmitter, the physical layer takes charge of retransmission. A receiver combines a previously received signal with a retransmitted signal, thereby correcting errors. That is, the HARQ scheme can solve the problem of a long error processing time encountered in the RLP retransmission because the physical layer decides as to whether or not to retransmit data. Also, previously received packet data having errors can be reused.

Even when the HARQ scheme is used, RLP retransmission maybe needed for some packets due to a limit on the number of retransmissions. The HARQ scheme reduces the number of RLP HARQ retransmissions by limiting the error rate of final combined data, namely a residual error rate to 0.01 or less. Therefore, the number of RLP retransmission occurrences is significantly reduced when using the HARQ scheme, rather than when not using the HARQ scheme.

### SUMMARY OF THE INVENTION

An object of the present invention is to substantially solve at least the above problems and/or disadvantages and to provide at least the advantages below. Accordingly, an object of the present invention is to provide a method of fast assigning one or more HARQ channels for delivering packet data in a mobile communication system supporting a HARQ scheme.

Another object of the present invention is to provide a method of reducing forward interference in assigning one or more HARQ channels for delivering packet data in a mobile communication system supporting a HARQ scheme.

A further object of the present invention is to provide a method of increasing the use efficiency of an F-GCH (Forward Grant Channel) in a mobile communication system supporting a HARQ scheme.

The above objects are achieved by providing a method of efficiently assigning a plurality of reverse HARQ channels to an MS in a BS in a mobile communication system supporting the HARQ scheme.

According to one aspect of the present invention, to transmit reverse data to a BS, an MS transmits a reverse data rate request message to the BS, receives from the BS one grant message containing a reverse data rate, and transmits to the BS different packet data at every predetermined interval at the reverse data rate on a packet data channel.

According to another aspect of the present invention, to assign data rates for a plurality of reverse channels that deliver different packets to an MS, a BS generates one grant message to grant a data rate for at least two of the reverse channels, upon receipt of a reverse data rate request message from the MS, and transmits the grant message to the MS.

According to a further aspect of the present invention, to transmit reverse data to a BS on a plurality of reverse channels, an MS transmits a reverse data rate request message to the BS, receives from the BS one grant message containing a data rate for at least two reverse channels for the MS, and transmits to the BS different packet data at the data rate on the reverse channels assigned by the one grant message.

According to still another aspect of the present invention, in an apparatus for transmitting HARQ channel assignment information to an MS on one grant channel to assign one or more HARQ channels in a BS, a controller outputs HARQ channel assignment information including at least information about the number and data rate of assigned HARQ channels, an error detection bit adder adds error detection bits to the output of the controller, a tail bit encoder adds tail bits to the output of the error detection bit adder, for efficient decoding, an encoder encodes the output of the tail bit encoder and outputs code symbols, a repeater repeats the code symbols a predetermined number of times, a puncturer punctures the repeated symbols in a predetermined puncturing pattern, an interleaver interleaves the punctured symbols, a modulator modulates the interleaved symbols in a predetermined modulation scheme, and a spreader spreads the modulated symbols with a predetermined orthogonal code and transmits the spread symbols by one grant message.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates transmission/reception of packet data in a mobile communication system supporting a reverse HARQ scheme in the present invention;

FIG. 2 illustrates assignment of one reverse HARQ channel from a BS to an MS in a mobile communication system supporting a reverse HARQ scheme in the present invention;

FIG. 3 illustrates assignment of three reverse HARQ channels from a BS to an MS in another mobile communication system supporting a reverse HARQ scheme in the present invention;

FIG. 4 illustrates a HARQ operation in the MS when one R-PDCH is assigned through one F-GCH transmission according to an embodiment of the present invention;

FIG. 5 is a block diagram of an embodiment of a transmitter for transmitting channel assignment information about a plurality of HARQ channels on an F-GCH according to the present invention;

FIG. 6 illustrates a HARQ operation in the MS when one or more R-PDCHs are assigned through two F-GCH transmissions according to another embodiment of the present invention;

FIG. 7 illustrates a HARQ operation with a boosted TPR in the MS according to a third embodiment of the present invention;

FIG. 8 is a flowchart illustrating a control operation for boosting a TPR for data retransmission in the MS according to the third embodiment of the present invention;

FIG. 9 illustrates a HARQ operation with a rate control based on an RCB (Rate Control Bit) in the MS according to a fourth embodiment of the present invention;

FIG. 10 is a flowchart illustrating a control operation for controlling a reverse data rate for data retransmission in the MS according to the fourth embodiment of the present invention; and

FIG. 11 is a block diagram of another embodiment of a transmitter for transmitting channel assignment information about a plurality of HARQ channels on the F-GCH according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

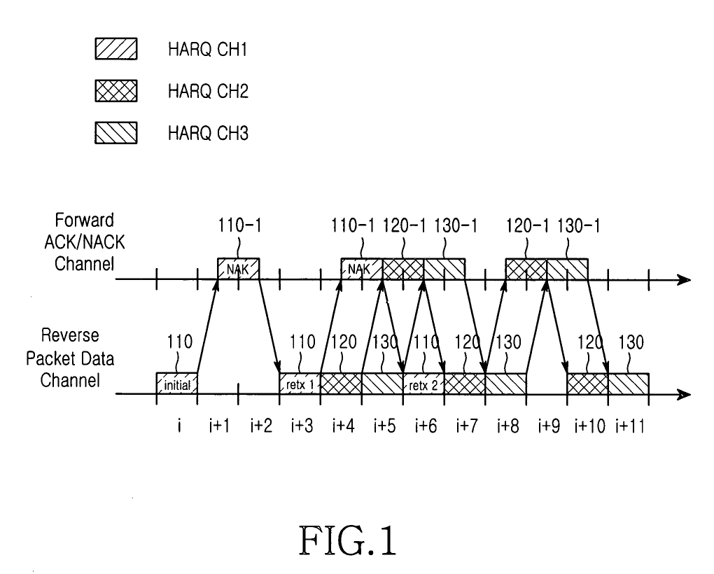

FIG. 1 is a view illustrating transmission/reception of reverse traffic data in a mobile communication system using a HARQ scheme.

Referring to FIG. 1, an R-PDCH (Reverse Packet Data Channel) is a traffic channel that delivers data from an MS to a BS, supporting the HARQ scheme. A HARQ scheme illustrated in FIG. 1 is implemented in a synchronous manner. Traffic information, an EP (Encoder Packet) is retransmitted at predetermined intervals and up to three HARQ channels are available. The term “synchronous” means that an EP whose transmission starts in an i^{th} time slot is retransmitted only in (i+3N)^{th} time slots until it is completely received or completely fails. For example, if an EP is transmitted in the i^{th} time slot, its first retransmission occurs in an (i+3)^{th} time slot and its second retransmission occurs in an (i+6)^{th} time slot. When three HARQ channels are available as illustrated in FIG. 1, they can be used respectively in (i+3N)^{th}, (i+3N+1)^{th}, and (i+3N+2)^{th} time slots. [It means each channel. For example, 1^{st} ch is assigned in (I+3N)^{th} slot, 2^{nd} channel is assigned in (i+3N+1)^{th} and 3^{nd} channel is assigned in (i+3N+2)^{th} respectively.] The three channels are denoted by HARQ CH1, HARQ CH2 and HARQ CH3. If four HARQ channels are available, they can be used respectively in (i+4N)^{th}, (i+4N+1)^{th}, (i+4N+2)^{th} and (i+4N+3)^{th} time slots.

Retransmission using the three HARQ channels in the illustrated case of FIG. 1 will be described. In FIG. 1, reference numerals 110, 120 and 130 denote first through third R-PDCHs, respectively. Reference numerals 110-1, 120-1 and 130-1 denote respective response channels for the first through third R-PDCHs.

In reverse packet data transmission, an MS transmits a first subpacket for new traffic (i.e. an EP) in the i^{th} time slot on the first R-PDCH 110. This is called an initial transmission. If a BS fails to receive the initially transmitted subpacket without errors, i.e. the subpacket has errors, it transmits an “NAK” signal on the response channel 110-1, notifying that a decoding error has been generated in the subpacket. Upon receipt of the NAK signal, the MS transmits to the BS a second subpacket for the same EP in the (i+3)^{th} time slot on the first R-PDCH 110. This transmission is called a first retransmission (retx 1). If the BS also fails to receive the first retransmitted subpacket without errors, it transmits an NAK signal to the MS on the response channel 110-1. Then, the MS transmits to the BS a third subpacket for the same EP in the (i+6)^{th} time slot on the first R-PDCH 110. This transmission is called a second retransmission (retx 2).

In general, the HARQ scheme is implemented after the number of available HARQ channels and the number of subpackets transmittable for one EP are determined.

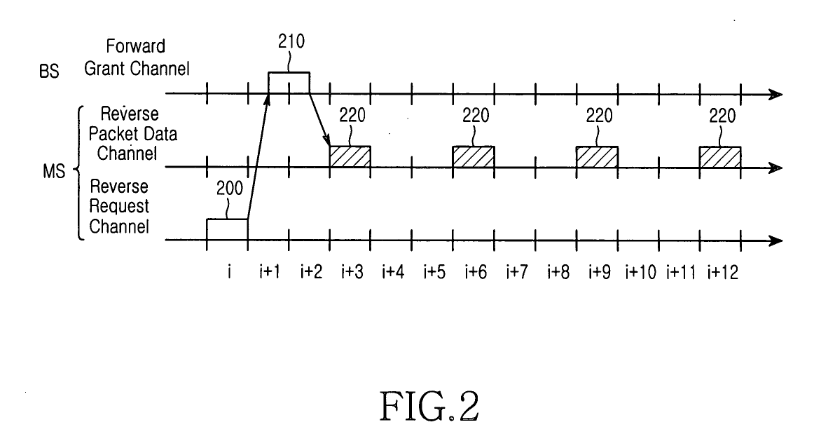

FIG. 2 illustrates assignment of reverse system capacity from a BS to an MS in a mobile communication system supporting reverse a HARQ scheme. The MS requests a particular data rate to the BS, and the BS notifies the MS of an allowed maximum data rate for a PDCH as a HARQ channel.

Referring to FIG. 2, when the MS needs to transmit reverse data, it generates a request message 200 and transmits the request message 200 to the BS in an i^{th} time slot on an R-REQCH (Reverse REQuest Channel), requesting assignment of a predetermined system capacity. The request message 200 contains information about the buffer status of the MS, a maximum available data rate or TPR (Traffic to Pilot Ratio), or/and quality of serviceinformation. The buffer status information indicates the amount of reverse data buffered in the buffer of the MS. Thus, the BS can determine from the buffer status information how urgent assignment of reverse system capacity is to the MS. Also, the MS can determine from the maximum available data rate or TPR how much system capacity the MS can occupy at maximum. The quality of service information notifies the BS of the type of reverse data that the MS is to transmit. The BS can control the time delay and error probability of the reverse data transmission based on the quality of service information.

Upon receipt of the request message 200 on the R-REQCH, the BS, if it determines to assign the reverse system capacity to the MS, transmits channel assignment information (e.g. HARQ channel assignment information) 210 to the MS on an F-GCH (Forward Grant Channel). The HARQ channel assignment information 210 contains a MAC (Medium Access Control) ID (Identifier) identifying the MS and an allowed maximum data rate or an allowed maximum TPR for the MS. A MAC ID identifies an MS that a BS services and thus each MS has a unique MAC ID. The reason for using an MS-specific MAC ID is that the F-GCH is transmitted to one MS each time. The BS indicates to an MS that the F-GCH is destined for, by the MAC ID of the MS. The allowed maximum data rate or TPR set in the F-GCH tells the MS how much system capacity is available to the MS.

In the illustrated case of FIG. 2, one HARQ channel is assigned by the F-GCH to allocate reverse link system capacity. The MS, receiving the F-GCH for the R-REQCH transmitted in the i^{th} time slot, starts to transmit reverse data on the HARQ channel in (i+3N)^{th} time slots starting from an (i+3)^{th} time slot of an assigned first R-PDCH 220 at or below the allowed maximum data rate or TPR. In this HARQ channel assignment, only one HARQ channel is available via the F-GCH. In other words, even after receiving the F-GCH, the MS cannot occupy the same system capacity using a HARQ channel in an (i+3N+1)^{th} time slot and an HARQ channel in an (i+3N+2)^{th} time slot.

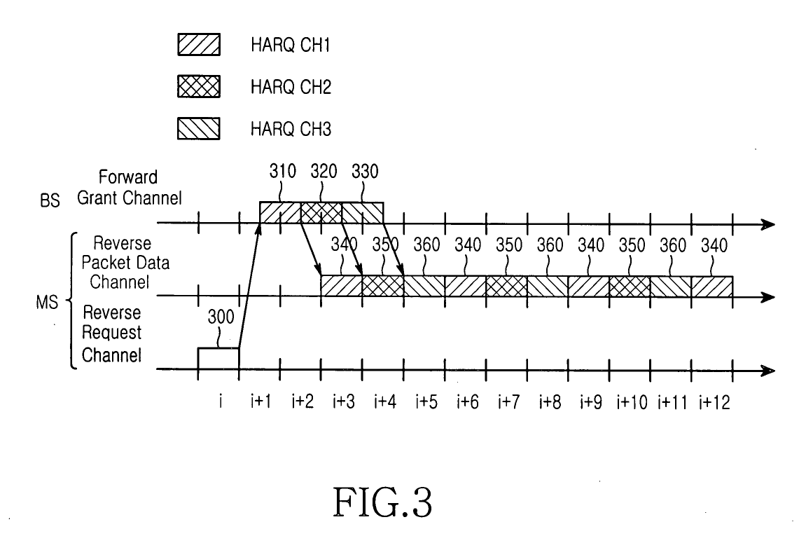

FIG. 3 illustrates assignment of reverse system capacity from a BS to an MS in another mobile communication system supporting the reverse HARQ scheme. The MS requests a particular data rate to the BS, and the BS notifies the MS of an allowed maximum data rate for three PDCHs as HARQ channels.

As described before with reference to FIG. 2, the BS cannot assign the system capacity of a plurality of HARQ channels by one F-GCH transmission. Thus, as many F-GCH transmissions as the number of HARQ channels to be assigned occur to assign the system capacity of the HARQ channels. Referring to FIG. 3, the BS transmits the F-GCH three times as indicated by reference numerals 310, 320 and 330 to assign HARQ channels 340, 350 and 360. Transmissions of the HARQ channels 340, 350 and 360 are confined to (i+3N)^{th}, (i+3N+1)^{th}, and (i+3N+2)^{th} time slots, respectively.

The transmissions of the F-GCH to assign the reverse capacity of a plurality of HARQ channels as illustrated in FIG. 3 increases forward F-GCH interference. In the case where one MS occupies the F-GCH as described above, the F-GCH cannot be transmitted for other MSs in the same time slot. This is because the number of F-GCHs available in the same time slot is usually limited.

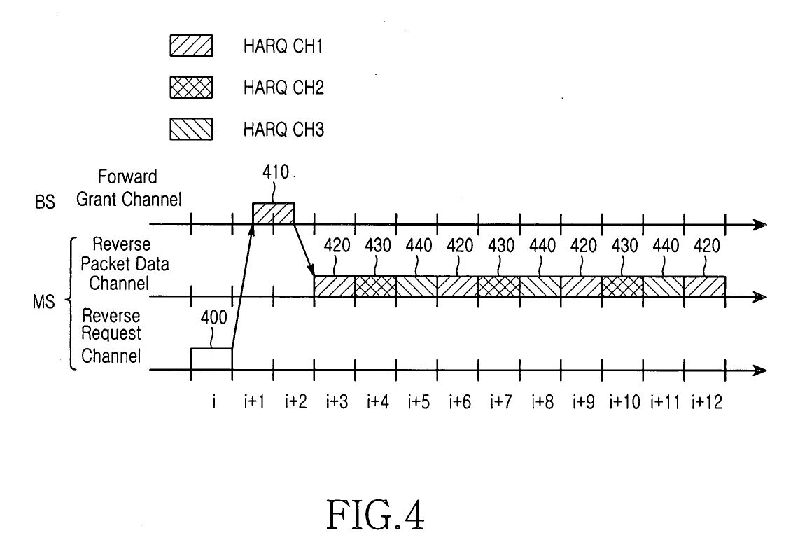

FIG. 4 illustrates a HARQ operation in an MS according to an embodiment of the present invention. The embodiment of the present invention is characterized in that a BS assigns the reverse system capacity of a plurality of HARQ channels to the MS by one F-GCH transmission.

Referring to FIG. 4, the MS transmits a request message 400 to the BS in an i^{th} time slot on an R-REQCH, requesting assignment of reverse system capacity. The BS then generates channel assignment information (i.e. HARQ channel assignment information) 410 to grant reverse transmission of packet data to the MS and transmits it to the MS on an F-GCH. The HARQ channel assignment information 410 further contains additional information, compared to the conventional channel assignment information on the F-GCH in the cases illustrated in FIGS. 2 and 3.

The HARQ channel assignment information 410 transmitted on the F-GCH includes “multiple HARQ channel assignment” in addition to the channel assignment information on the F-GCH, that is, a MAC ID and an allowed maximum data rate or TPR. The “multiple HARQ channel assignment” indicates which HARQ channel or channels are assigned to the MS among a plurality of available HARQ channels. For example, if three HARQ channels 420, 430 and 440 are available at the same time as illustrated in FIG. 4, the “multiple HARQ channel assignment” tells the MS how many HARQ channels and what HARQ channels are assigned to it.

Table 1 below lists the values of “multiple HARQ channel assignment” and their meanings when three HARQ channels are available at the same time as illustrated in FIG. 4.

TABLE 1

| F-GCH sequence of | |
|---|---|
| multiple HARQ channel | |
| assignment | meaning |
| 00 | HARQ CH1 assigned |
| 01 | HARQ CH1 and HARQ CH2 assigned |
| 10 | HARQ CH1, HARQ CH2, |
| | and HARQ CH3 assigned |
| 11 | HARQ CH1 and HARQ CH3 assigned |

In Table 1, HARQ CH1 is the earliest of the three HARQ channels that can be assigned by the F-GCH. HARQ CH1 is the first R-PDCH 420. HARQ CH2 is the second earliest HARQ channel 430 that can be assigned by the F-GCH, and HARQ CH3 is the last HARQ channel 440 that can be assigned by the F-GCH. When receiving the F-GCH, the MS establishes HARQ CH1, HARQ CH2 and HARQ CH3 in the (i+3)^{th}, (i+4)^{th}, and (i+5)^{th} time slots, respectively.

Table 2 below lists the values of “multiple HARQ channel assignment” and their meanings when four HARQ channels are available at the same time.

TABLE 2

| F-GCH sequence | |
|---|---|
| of multiple HARQ | |
| channel assignment | meaning |
| 000 | HARQ CH1 assigned |
| 001 | HARQ CH1 and HARQ CH2 assigned |
| 010 | HARQ CH1 and HARQ CH3 assigned |
| 011 | HARQ CH1 and HARQ CH4 assigned |
| 100 | HARQ CH1, HARQ CH2, |
| | and HARQ CH3 assigned |
| 101 | HARQ CH1, HARQ CH3, |
| | and HARQ CH4 assigned |
| 110 | HARQ CH1, HARQ CH2, |
| | and HARQ CH4 assigned |
| 111 | HARQ CH1, HARQ CH2, HARQ CH3, |
| | and HARQ CH4 assigned |

Referring to Table 2, HARQ CH1 is the earliest of the four HARQ channels that can be assigned by the F-GCH. HARQ CH2 and HARQ CH3 are the second and third HARQ channels, respectively, and HARQ CH4 is the last HARQ channel that can be assigned by the F-GCH.

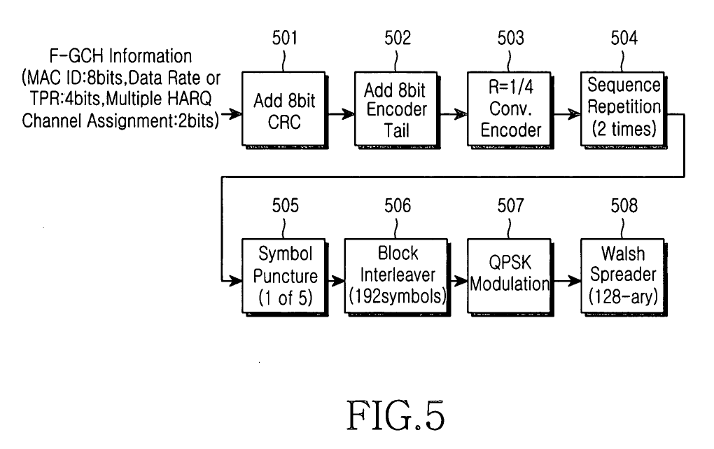

FIG. 5 is a block diagram an embodiment of a transmitter for transmitting a multiple HARQ channel assignment sequence on the F-GCH according to the present invention. With reference to FIG. 5, the configuration and operation of the transmitter will be described below.

Referring to FIG. 5, HARQ channel assignment information transmitted on the F-GCH contains an 8-bit MAC ID, a 4-bit allowed maximum data rate or TPR, and a 2-bit multiple HARQ channel assignment. The HARQ channel assignment information is usually output from a scheduler or controller (not shown in FIG. 5) of the BS. In the illustrated case of FIG. 5, up to three HARQ channels are available at the same time and assigned via the F-GCH.

A CRC (Cyclic Redundancy Code) encoder 501 attaches an 8-bit CRC to the 14-bit HARQ channel assignment information, for detection of transmission errors. A tail encoder 502 attaches 8 tail bits to the 22 information bits received from the CRC encoder 501, for efficient decoding of a convolutional code with K=9. The resulting 30 information bits are provided to a convolutional encoder 503. In the embodiment of the present invention, a coding rate of 1/4 (R=1/4) is used in the convolutional encoder 503, by way of example. The convolutional encoder 503 encodes the 30 information bits to 120 code symbols. The code symbols occur twice in a sequence repeater 504. Therefore, the output of the sequence repeater 504 is 240 code symbols. A puncturer 505 punctures 48 symbols in the 240 code symbols, that is, 1 symbol out of every 5 symbols and outputs 192 symbols. A block interleaver 506 block-interleaves the 192 symbols. A modulator, for example, a QPSK (Quadrature Phase Shift Keying) modulator 507 modulates the 192 symbols to 96 modulation symbols. An orthogonal spreader 508 spreads the 96 modulation symbols with an orthogonal code of length 128. The spread signal is then transmitted on a radio channel. Here, the components designated as reference numerals 501 to 508 make up a transmitter.

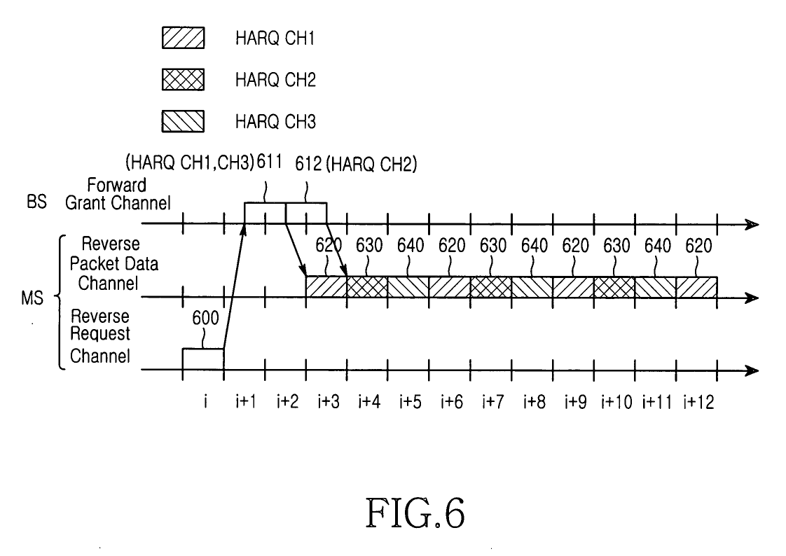

In this HARQ channel assignment scheme, the BS can assign one or more HARQ channels at one time as illustrated in FIG. 4, with reference to Table 1 and Table 2. Alternatively, the HARQ channels can be assigned through two or more F-GCH transmissions, as illustrated in FIG. 6.

FIG. 6 illustrates assignment of one or more R-PDCHs to the MS by two F-GCH transmissions according to another embodiment of the present invention.

Referring to FIG. 6, the MS transmits a request message 600 to the BS, requesting assignment of reverse system capacity. The BS then assigns HARQ channels to the MS by transmitting the F-GCH twice. First HARQ assignment information 611 of the F-GCH assigns HARQ CH1 and HARQ CH3. According to Table 2, the BS sets “multiple HARQ assignment” to 010. Second HARQ assignment information 612 of the F-GCH assigns HARQ CH2. Thus, the BS sets “multiple HARQ assignment” to 000 because HARQ CH2 is the earliest HARQ channel that can be assigned by the second HARQ assignment information 612. Upon receipt of the HARQ assignment information 611 and the HARQ assignment information 612, the MS establishes HARQ channels 620, 630 and 640.

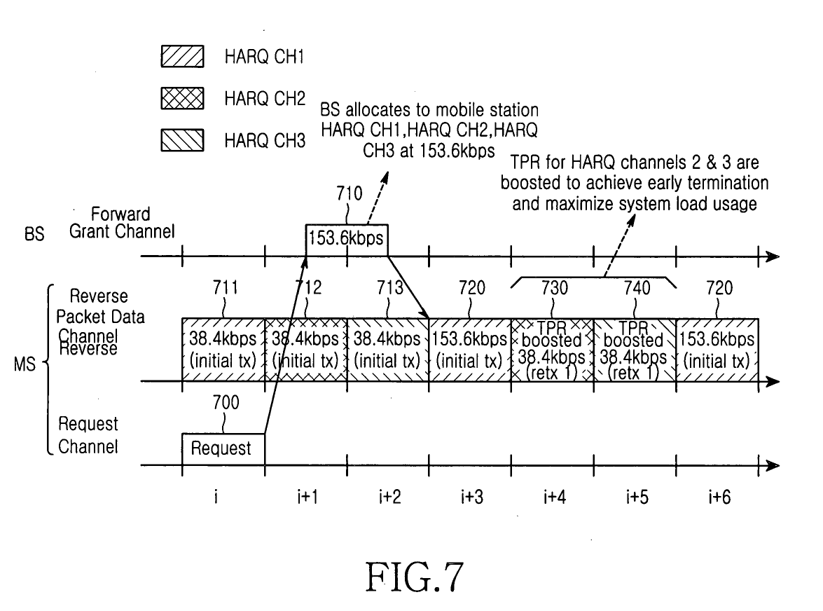

FIG. 7 illustrates a HARQ operation in the MS according to a third embodiment of the present invention. In FIG. 7, the BS assigns the reverse system capacity of three reverse HARQ channels to the MS by one F-GCH transmission. When the MS needs to retransmit packet data, it utilizes as much of the assigned system capacity as possible.

Referring to FIG. 7, upon receipt of a request message 700 requesting assignment of a reverse link on an R-REQCH from the MS, the BS transmits to the MS HARQ channel assignment information 710 on the F-GCH, for assigning the reverse system capacity of three HARQ channels HARQ CH1 720, HARQ CH2 730, and HARQ CH3 740. It is assumed herein that the BS allows a maximum data rate of 153.6 kbps for the three HARQ channels 720, 730 and 740. After receiving the F-GCH, the MS is capable of transmitting data at 153.6 kbps on each of HARQ CH1, HARQ CH2 and HARQ CH3. The MS can transmit reverse data at a default data rate, for example, 38.4 kbps, while requesting the R-PDCHs via the R-REQCH. Hence, the MS, while requesting assignment of a reverse data rate on the R-REQCH, transmits first data 711 on HARQ CH1 corresponding to a first R-PDCH, second data 712 on HARQ CH2 corresponding to a second R-PDCH, and third data 713 on HARQ CH3 corresponding to a third R-PDCH. The reverse channels and data rate assigned by the BS can be used first in a (i+3)^{th} time slot after the data transmission at the default data rate. That is, after receiving the HARQ channel assignment information 710, the MS starts to operate in the (i+3)^{th} time slot as indicated by the HARQ assignment information.

The BS successfully receives the initially transmitted packet data 711 at 38.4 kbps in an i^{th} time slot, but fails to receive the initially transmitted packet data 712 and 713 at 38.3 kbps in (i+1)^{th} and (i+2)^{th} time slots.

The BS assigns the reverse system capacity to the MS such that reverse transmission can start at 153.6 kbps in the (i+3)^{th} time slot. However, despite the assignment of 153.6 kbps, the MS cannot transmit data at 153.6 kbps in (i+4)^{th} and (i+5)^{th} time slots because the same data is supposed to be retransmitted at the same data rate. Hence, the MS retransmits the initially transmitted data at 38.4 kbps. Data retransmission is carried out on the second R-PDCH 730 and the third R-PDCH 740 according to the present invention. In the case where data is retransmitted at a data rate lower than the allowed maximum data rate set in the F-GCH, the MS retransmits subpackets with a boosted TPR in the (i+4)^{th} time slot on the second R-PDCH 730 and in the (i+5)^{th} time slot on the third R-PDCH 740. The TPR is a ratio of the transmit power of an R-PDCH to that of a reverse pilot channel. It is preset for each data rate as illustrated in Table 3.

TABLE 3

| Data rate | TPR |
|---|---|
| 19.2 kbps | 1 dB |
| 38.4 kbps | 3.75 dB |
| 76.8 kbps | 5 dB |
| 153.6 kbps | 7 dB |
| 307.2 kbps | 9 dB |
| 614.4 kbps | 10 dB |

In the (i+4)^{th} and (i+5)^{th} time slots, the data is retransmitted at 38.4 kbps with a TPR of 7 dB corresponding to 153.6 kbps, instead of 3.75 dB corresponding to 38.4 kbps. The TPR boosting is done for the purpose of allowing the MS to maximize the use of the assigned system capacity and thus increasing the reception probability of the retransmitted packets in the BS. With the data retransmission with the boosted TPR, the number of transmissions required for the BS to receive the EPs without errors is reduced.

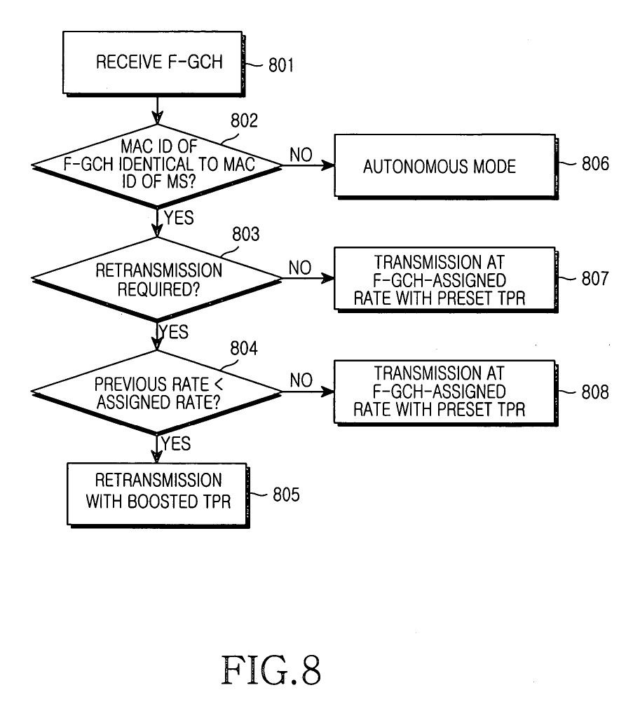

FIG. 8 is a flowchart illustrating a control operation for boosting a TPR for data retransmission in the MS that has received HARQ channel assignment information on the F-GCH according to the third embodiment of the present invention.

Referring to FIG. 8, after requesting reverse channel assignment on the R-REQCH, the MS monitors HARQ channel assignment information on the F-GCH in every time slot in step 801. In step 802, the MS determines whether the F-GCH information is destined for the MS. If it is, the MS proceeds to step 803 and if it is not, the MS proceeds to step 806. The determination is made by comparing a MAC ID set in the HARQ channel assignment information with the MAC ID of the MS.

In step 806, the MS establishes an R-PDCH in an autonomous mode and transmits reverse packet data on the R-PDCH. The autonomous mode refers to a mode where the MS chooses one of autonomous mode data rates pre-assigned by the BS and transmits packet data at the chosen data rate on an R-PDCH. In general, a data rate available to the MS in the autonomous mode is lower than that assigned by the BS via the F-GCH. Yet, the autonomous mode data rate is not always lower than the data rate assigned by the F-GCH.

Meanwhile, when the MS proceeds from step 802 to step 803, which implies that the F-GCH delivers HARQ channel assignment information for the MS, it controls its data rate. As described above with reference to FIG. 7, the packet data has already been transmitted before a reverse channel is assigned for packet data transmission. Therefore, the MS determines whether a retransmission is needed for the previous packet data transmitted before the R-PDCH assignment in step 803.

If the previous packet data is to be retransmitted like the retransmission of the data transmitted before F-GCH reception in the (i+4)^{th} and (i+5)^{th} time slots in FIG. 7, the MS proceeds to step 804. If the retransmission is not required, the MS determines a data rate according to the F-GCH information and sets a TPR for the determined data rate referring to Table 3 in step 807. The TPRs of Table 3 are predetermined and stored in the MS. Alternatively, they are determined by agreement between the BS and the MS before packet data transmission and stored in the MS.

In step 804, the MS compares the data rate of the packet data to be retransmitted with an allowed maximum data rate set in the F-GCH information. If the data rate of the packet data selected in the autonomous mode is lower than the maximum data rate, the MS proceeds to step 805. If the data rate of the packet data is equal to or higher than the maximum data rate, the MS proceeds to step 808.

In step 805, the MS boosts the TPR for data retransmission, as described with reference to FIG. 7. Meanwhile, the MS retransmits the packet data without boosting the TPR, that is, with the preset TPR corresponding to the data rate of the packet data in step 808. If the data rate selected in the autonomous mode is higher than the F-GCH-assigned data rate, the data retransmission can be carried out by lowering the TPR, i.e. TPR dropping, that is, using the TPR of the F-GCH-assigned data rate.

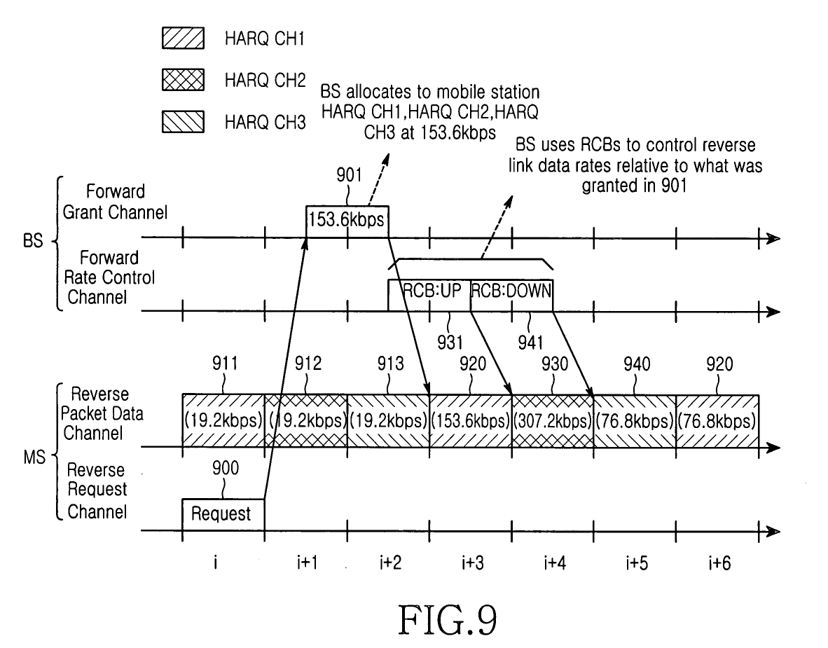

FIG. 9 illustrates a HARQ operation along with control of a data rate in the MS according to a fourth embodiment of the present invention. In FIG. 9, the BS assigns the reverse system capacity of three reverse HARQ channels to the MS by one F-GCH transmission. Besides the F-GCH, the BS provides an additional fine control to the reverse system capacity using an RCB (Rate Control Bit) of an F-RCCH (Forward Rate Control CHannel).

Referring to FIG. 9, the MS transmits a request message 900 to the BS on the R-REQCH, requesting reverse data transmission. At the same time, the MS transmits reverse packet data 911, 912 and 913 as agreed beforehand between the BS and the MS. Upon receipt of the request message 900, the BS checks whether R-PDCHs are available to the MS. If they are available, the BS determines reverse capacity to assign to the MS and transmits HARQ channel assignment information 901 to the MS on the F-GCH. In the illustrated case of FIG. 9, three HARQ channels, HARQ CH1, HARQ CH2 and HARQ CH3 are assigned at 153.6 kbps to the MS. These HARQ channels are assigned in the manner illustrated in FIG. 7. Yet, FIG. 9 differs from FIG. 7 in that the BS controls the reverse system capacity assigned to the MS via the F-RCCH as well as the F-GCH.

Now, a method of controlling reverse system capacity via the F-RCCH will be described. In FIG. 9, the BS assigns the reverse system capacity of three HARQ channels to the MS via the F-GCH. More specifically, the BS assigns a maximum data rate of 153.6 kbps for data transmission starting from (i+3)^{th}, (i+4)^{th} and (i+5)^{th} time slots. The BS then additionally transmits the F-RCCH to the MS in order to provide a fine control to the reverse system capacity assigned in the (i+4)^{th} and (i+5)^{th} time slots. That is, after being assigned the system capacity via the F-GCH, the MS establishes first through third R-PDCHs 920, 930 and 940. The first R-PDCH 920 is maintained at a maximum data rate set in the F-GCH information, whereas the data rates of the second and third R-PDCHs 930 and 940 are controlled via the F-RCCH. The BS transmits a 1-bit RCB to the MS on the F-RCCH in each time slot. If the RCB is “+1”, the MS increases the data rate of the second R-PDCH 930 to be higher than that of the first R-PDCH 920. Thus, the second R-PDCH 930 delivers packet data at 307.2 kbps. Shortly after transmitting the RCB of +1, the BS transmits an RCB of −1 to the MS. Since the data rate of the first PDCH 920 is assigned by the F-GCH, the MS decides the data rate of the third R-PDCH 940 relative to the data rate of the first PDCH 920. Here, the RCB of −1 indicates a data rate decrease for the third PDCH 940. Thus, the MS transmits packet data on the third R-PDCH 940 at 76.8 kbps. If the RCB is not received on the F-RCCH, this implies that the data rate of the second or third R-PDCH 930 or 940 is to be maintained at that of the first R-PDCH 920.

When the BS transmits the F-RCCH in the manner illustrated in FIG. 9, the MS operates as follows. The BS assigns HARQ CH1, HARQ CH2 and HARQ CH3 at 153.6 kbps to the MS. The MS then determines that reverse system capacity has been assigned at 153.6 kbps by HARQ CH1 in the (i+3)^{th} time slot. Regarding HARQ CH2 and HARQ CH3, the MS calculates its assigned reverse system capacity based on 153.6 kbps set in the F-GCH and an RCB set in the F-RCCH. For example, the MS determines 307.2 kbps as its assigned reverse system capacity for HARQ CH2 in the (i+4)^{th} time slot because the F-GCH indicates 153.6 kbps but the RCB of the F-RCCH is “+1” indicating a rate increase. Also, the MS determines 76.8 kbps as its assigned reverse system capacity for HARQ CH3 in the (i+5)^{th} time slot because the F-GCH indicates 153.6 kbps but the RCB of the F-RCCH is “−1” indicating a rate decrease. In the above case, one increment and one decrement of 153.6 kbps are assumed to be 307.2 kbps and 76.8 kbps, respectively, based on Table 3.

The fine control of the reverse system capacity via the F-RCCH illustrated in FIG. 9 is applicable when the BS assigns a plurality of HARQ channels via the F-GCH. In this case, the BS transmits the F-RCCH for the remaining HARQ channels except for the earliest HARQ channel which can be assigned by the F-GCH among a plurality of assigned HARQ channels, thereby controlling the system capacity of the remaining HARQ channels. In FIG. 9, the BS provides an additional fine control to HARQ CH2 and HARQ CH3 via the F-RCCH, except HARQ CH1 in the (i+3)^{th} time slot, the earliest HARQ channel to which the F-GCH is applicable. For the additional fine control, the data rate set in the F-GCH is a reference data rate.

While the BS assigns an allowed maximum data rate to the MS via the F-GCH, the above method is performed in the same manner although an allowed maximum TPR is set in the F-GCH instead of the maximum data rate. If a maximum TPR is set in the F-GCH in FIG. 9, the F-RCCH is so configured as to indicate TPR boosting/dropping, instead of rate up/down.

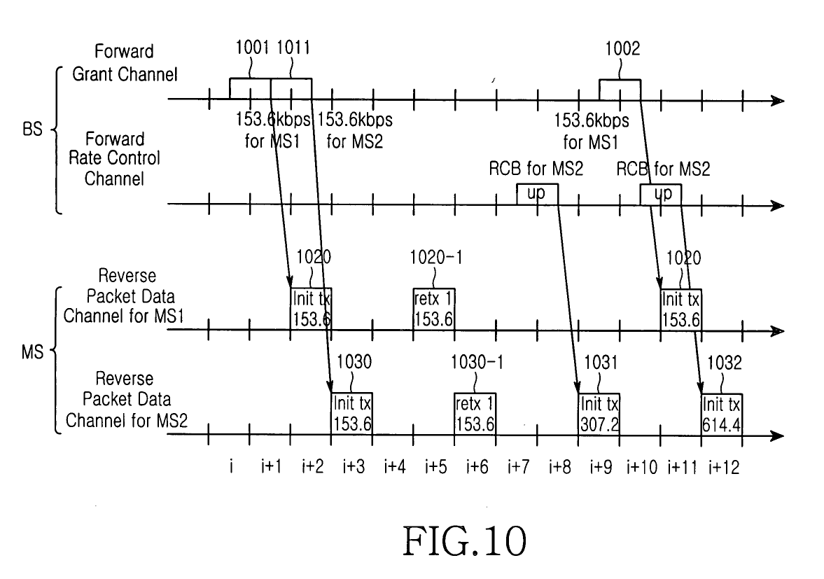

FIG. 10 illustrates HARQ operations in MSs according to a fourth embodiment of the present invention.

Referring to FIG. 10, the BS transmits HARQ channel assignment information 1001 and 1011 to two MSs, MS1 and MS2 via the F-GCH, respectively. Upon receipt of the HARQ channel assignment information 1001, MS1 transmits packet data 1020 at a data rate set in the received information 1001. Upon receipt of the HARQ channel assignment information 1011, MS2 transmits packet data 1030 at a data rate set in the received information 1011. While the HARQ channel assignment information 1001 and the HARQ channel assignment information 1011 commonly assign reverse system capacity to MS1 and MS2, they have different assignment contents. The destination of HARQ channel assignment information on the F-GCH is identified by a MAC ID set therein.

In FIG. 10, the BS assigns one R-PDCH at 153.6 kbps to MS1 via the F-GCH. Thus, MS1 transmits only one packet at 153.6 kbps after receiving the F-GCH and performs additional data transmission on the HARQ channel in the autonomous mode. MS1 cannot additionally transmit data on another HARQ channel at 153.6 kbps until it receives the F-GCH one more time. That is, MS1 transmits the packet data on the first R-PDCH. Upon request for a retransmission of the packet data 1020, the MS transmits retransmission packet data 1020-1 for the initially transmitted packet data 1020 on the first R-PDCH.

As stated before, the BS also transmits the HARQ channel assignment information 1011 that assigns 153.6 kbps to MS2. Notably, the data rate of MS2 is further controlled. The BS allows MS2 to start to transmit packet data at 153.6 kbps via the F-GCH and controls the data rate for data transmission starting with the second EP on the HARQ channel by an RCB of the F-RCCH. After receiving the HARQ channel assignment information 1011, MS2 recognizes that the first EP is supposed to be transmitted at an allowed maximum data rate set in the F-GCH information 1011.

Thus, MS2 transmits the packet data 1030 at 153.6 kbps set in the F-GCH in the (i+3)^{th} time slot. When the BS fails to receive the packet data 1030, MS2 transmits retransmission packet data 1030-1 for the data 1030 in an (i+6)^{th} time slot. The BS then controls the data rate of MS2 for the next packet data 1031 to be transmitted on the HARQ channel by an RCB of the F-RCCH. Thus, the BS transmits the RCB set to +1 to MS2. Then MS2 increases its data rate to 307.2 kbps in an (i+9)^{th} time slot.

To allow an MS to transmit only one packet data and to allow another MS to transmit one packet data and then adjust its data rate based on the RCB of the F-RCCH, the BS transmits HARQ channel assignment information to the first and second MSs in different F-GCH messages. To do so, the HARQ channel assignment information is configured to further have “multiple EP assignment”. The values of “multiple EP assignment” and their meanings are tabulated in Table 4 below.

TABLE 4

| Multiple EP | |
|---|---|
| assignment | Meaning |
| 0 | Maximum data rate set in F-GCH is applied to only |
| | one EP. After transmitting the EP, MS transitions to |
| | autonomous mode |
| 1 | Maximum data rate set in F-GCH is applied to a |
| | plurality of EPs. After transmitting the EPs, MS |
| | transitions to rate controlled mode. The data rate |
| | set in F-GCH is a reference data rate for the rate |
| | controlled mode. |

By further including 1-bit “multiple EP assignment” illustrated in Table 4 in the HARQ channel assignment information, the BS allows the MS to adjust its data rate based on the RCB, change the data rate to a fixed value by the F-GCH, or controls the data rate in the autonomous mode.

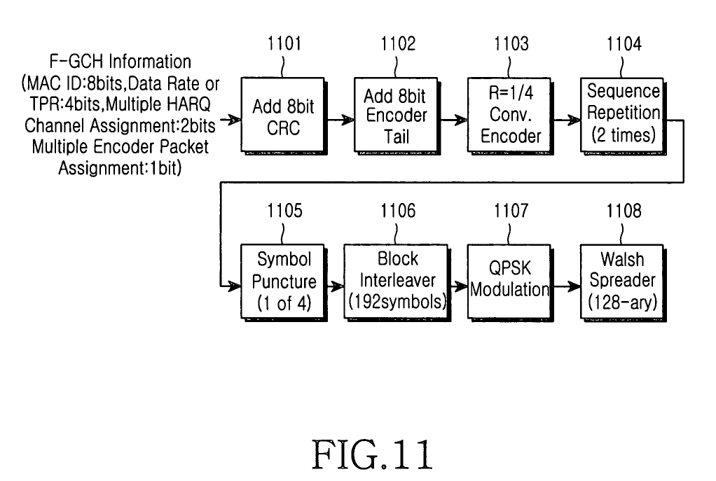

FIG. 11 is a block diagram of another embodiment of the transmitter for transmitting HARQ channel assignment information on the F-GCH.

Referring to FIG. 11, the HARQ channel assignment information transmitted on the F-GCH contains an 8-bit MAC ID, a 4-bit allowed maximum data rate or TPR, a 2-bit multiple HARQ channel assignment, and a 1-bit multiple EP assignment. The F-GCH delivers the HARQ channel assignment information to assign up to three available HARQ channels.

A CRC encoder 1101 attaches an 8-bit CRC to the 15-bit F-GCH information, for detection of transmission errors. A tail encoder 1102 attaches 8 tail bits to the 23 information bits received from the CRC encoder 1101, for efficient decoding of a convolutional code with K=9. The resulting 31 information bits are provided to a convolutional encoder 1103. In the embodiment of the present invention, a coding rate of 1/4 (R=1/4) is used in the convolutional encoder 1103, by way of example. The convolutional encoder 1103 encodes the 31 information bits to 124 code symbols. The code symbols occur twice in a sequence repeater 1104. Therefore, the output of the sequence repeater 1104 is 248 code symbols. A puncturer 1105 punctures 56 symbols in the 248 code symbols, specifically punctures 1 symbol out of every 4 symbols and outputs 192 symbols. A block interleaver 1106 block-interleaves the 192 symbols. A modulator, for example, a QPSK modulator 1107 modulates the 192 symbols to 96 modulation symbols. An orthogonal spreader 1108 spreads each of the 96 modulation symbols with an orthogonal code of length 128. The spread signal is then transmitted on a radio channel.

As described above, the present invention advantageously assigns HARQ channels fast, reduces forward interference involved in the HARQ channel assignment, and increases the use efficiency of the F-GCH in a mobile communication system supporting the HARQ scheme.

While the invention has been shown and described with reference to certain preferred embodiments thereof, it will be understood by those skilled in the art that various changes in form and details may be made therein without departing from the spirit and scope of the invention as defined by the appended claims.

1. A method of transmitting reverse data to a base station (BS) in a mobile station (MS), comprising the steps of:
transmitting a reverse data rate request message to the BS;
receiving one grant message from the BS, the grant message containing a reverse data rate for the MS; and
transmitting to the BS at least two packet data at predetermined intervals at the received reverse data rate on a packet data channel.

2. The method of claim 1, further comprising the steps of:
receiving rate control information from the BS, after receiving the grant message; and
changing the reverse data rate set in the grant message according to the rate control information.

3. The method of claim 1, wherein the reverse data rate request message contains buffer status information of the MS, an available maximum data rate, and quality of service information of traffic.

4. The method of claim 1, wherein the reverse data rate request message contains buffer status information of the MS, an available maximum traffic to pilot ratio (TPR), and quality of service information of traffic.

5. The method of claim 1, wherein the predetermined interval is set to be a predetermined number of reverse transmission time slots.

6. The method of claim 1, wherein the grant message contains an identifier (ID) of the MS, an allowed data rate for the MS, and a number of channels to be transmitted at the allowed data rate.

7. The method of claim 1, wherein the request message transmitting step comprises the step of initially transmitting a reverse packet at a data rate preset between the BS and the MS, and simultaneously transmitting the reverse data rate request message.

8. The method of claim 7, further comprising the step of retransmitting the initially transmitted packet at the data rate of the initial transmission, upon request for the retransmission from the BS.

9. A method of assigning a data rate for a plurality of reverse channels that deliver different packets to a mobile station (MS) in a base station (BS) in a mobile communication system, comprising the steps of:
generating one grant message to grant a same data rate for at least two reverse channels, upon receipt of a reverse data rate request message from the MS; and
transmitting the grant message to the MS.

10. The method of claim 9, further comprising the step of transmitting rate control information after the transmission of the grant message to control the data rate of a channel assigned after the grant message is received at the MS.

11. The method of claim 9, wherein the reverse data rate request message contains buffer status information of the MS, an available maximum data rate, and quality of service information of traffic.

12. The method of claim 9, wherein the reverse data rate request message contains buffer status information of the MS, an available maximum traffic to pilot ratio (TPR), and quality of service information of traffic.

13. The method of claim 9, wherein the plurality of reverse channels are identified by different transmission time slot indexes.

14. The method of claim 9, wherein the grant message contains an identifier (ID) of the MS, an allowed data rate for the MS, and a number of channels to be transmitted at the allowed data rate.

15. The method of claim 14, wherein the grant message further contains a rate application order of the channels.

16. The method of claim 9, further comprising the step of, upon receipt of an initially transmitted packet from the MS at a data rate preset between the BS and the MS along with the reverse data rate request message, transmitting a decoding result of the packet to the MS.

17. The method of claim 9, further comprising the step of, upon receipt of reverse data rate request messages from at least two MSs, transmitting one grant message to each of the at least two MSs.

18. The method of claim 17, wherein the one grant message contains information about a number of channels granted to the MS, an order of the channels, and a data rate allowed for the MS.

19. The method of claim 17, further comprising the step of generating rate control information after assigning a reverse channel of each of the MSs and transmitting the rate control information to the MS in order to control the data rate allowed for the MS.

20. The method of claim 9, wherein the plurality of reverse channels are HARQ (Hybrid Automatic Repeat reQuest) channels.

21. A method of transmitting reverse data to a base station (BS) on in a mobile station (MS), comprising the steps of:
transmitting a reverse data rate request message to the BS;
receiving one grant message from the BS, the grant message containing a data rate for at least two reverse channels for the MS; and
transmitting to the BS at least two packet data at the data rate on the reverse channels assigned by the one grant message.

22. The method of claim 21, further comprising the steps of:
receiving rate control information from the BS, after receiving the grant message; and
changing the reverse data rate set in the grant message according to the rate control information.

23. The method of claim 21, wherein the reverse data rate request message contains buffer status information of the MS, an available maximum data rate, and quality of service information of traffic.

24. The method of claim 21, wherein the reverse data rate request message contains buffer status information of the MS, an available maximum traffic to pilot ratio (TPR), and quality of service information of traffic.

25. The method of claim 21, wherein the plurality of reverse channels are HARQ channels.

26. The method of claim 21, wherein the grant message contains an identifier (ID) of the MS, an allowed data rate for the MS, and a number of channels to be transmitted at the allowed data rate.

27. The method of claim 21, wherein the request message transmitting step comprises the step of initially transmitting a reverse packet at a data rate preset between the BS and the MS, and simultaneously transmitting the reverse data rate request message.

28. The method of claim 27, further comprising the step of retransmitting the initially transmitted packet at the data rate of the initial transmission, upon request for the retransmission from the BS.

29. An apparatus for transmitting HARQ (Hybrid Automatic Repeat reQuest) channel assignment information to a mobile station (MS) on one grant channel to assign one or more HARQ channels in a base station (BS) in a mobile communication system, comprising:
a controller for outputting HARQ channel assignment information including at least information about a number and data rate of assigned HARQ channels;
an error detection bit adder for adding error detection bits to the output of the controller;
a tail bit encoder for adding tail bits to the output of the error detection bit adder, for efficient decoding;
an encoder for encoding the output of the tail bit encoder and outputting code symbols;
a repeater for repeating the code symbols a predetermined number of times;
a puncturer for puncturing the repeated symbols in a predetermined puncturing pattern;
an interleaver for interleaving the punctured symbols;
a modulator for modulating the interleaved symbols in a predetermined modulation scheme; and
a spreader for spreading the modulated symbols with a predetermined orthogonal code and transmitting the spread symbols by one grant message.

30. The apparatus of claim 29, wherein the number of assigned HARQ channels in the HARQ channel assignment information is at least two.

31. A method of transmitting reverse data to a base station (BS) in a mobile station (MS), comprising the steps of:
transmitting a reverse data rate request. message to the BS;
receiving a grant message from the BS, the grant message containing a data rate and information related to a HARQ channel for the MS; and
transmitting to the BS at least two packet data according to the data rate and the information.

32. The method of claim 31, wherein the information indicates whether the grant message applies to all HARQ channels.

33. A method in a base station (BS) of assigning a data rate for a plurality of reverse channels that deliver at least two packets to a mobile station (MS) in a mobile communication system, comprising the steps of:
generating one grant message upon receipt of a reverse data rate request message from the MS; and
transmitting the grant message to the MS, wherein the grant message contains a data rate and information related to a HARQ channel for the MS.

34. The method of claim 33 wherein the information indicates whether the grant message applies to all HARQ channels.

35. A apparatus for transmitting reverse data to a base station (BS) in a mobile station (MS), comprising:
means for transmitting a reverse data rate request message to the BS;
means for receiving a grant message from the BS, the grant message containing a data rate and information related to a HARQ channel for the MS; and
means for transmitting to the BS at least two packet data according to the data rate and the information.

36. The apparatus of claim 35 wherein the information indicates whether the grant message applies to all HARQ channels.

37. An apparatus in a base station (BS) for assigning a data rate for a plurality of reverse channels that deliver at least two packets to a mobile station (MS) in a mobile communication system, comprising:
a controller for generating one grant message upon receipt of a reverse data rate request message from the MS; and
a transmitter for transmitting the grant message to the MS.

38. The apparatus of claim 37, wherein the grant message contains a data rate and information related to a HARQ channel for the MS.

39. The apparatus of claim 37 wherein the information indicates whether the grant message applies to all HARQ channels.
